(19) United States
(12) Patent Application Publication
(10) Pub. No.: US 2016/0179668 A1
(43) Pub. Date: Jun. 23, 2016

(54) COMPUTING SYSTEM WITH REDUCED DATA EXCHANGE OVERHEAD AND RELATED DATA EXCHANGE METHOD THEREOF

(71) Applicant: MEDIATEK INC., Hsin-Chu (TW)

(72) Inventors: Yu-Cheng Chu, Hsinchu City (TW); Shen-Kai Chang, Hsinchu County (TW); Yong-Ming Chen, Taichung City (TW); Chi-Cheng Ju, Hsinchu City (TW)

(21) Appl. No.: 14/902,582

(22) PCT Filed: May 28, 2015
(86) PCT No.: PCT/CN2015/080088

§ 371 Date: Jan. 3, 2016

Related U.S. Application Data
(60) Provisional application No. 62/003,611, filed on May 28, 2014.

(51) Int. Cl. G06F 12/08; G06F 12/12; G06F 3/06

(52) U.S. Cl. CPC G06F 12/0804; G06F 3/0611; G06F 3/0656; G06F 3/0683; G06F 12/0811; G06F 12/12; G06F 2212/69; G06F 2212/1024; G06F 2212/621

(57) ABSTRACT

A computing system includes a plurality of processing circuits and a storage device. The processing circuits have at least a first processing circuit and a second processing circuit. The storage device is shared between at least the first processing circuit and the second processing circuit. The first processing circuit performs a whole cache flush operation to prepare exchange data in the storage device. The second processing circuit gets the exchange data from the storage device.

### CROSS REFERENCE TO RELATED APPLICATIONS

This application claims the benefit of U.S. provisional application No. 62/003,611, filed on May 28, 2014 and incorporated herein by reference.

### TECHNICAL FIELD

The disclosed embodiments of the present invention relate to a data exchange scheme, and more particularly, to a computing system (e.g., a heterogeneous computing system or a homogeneous computing system) with reduced data exchange overhead and a related data exchange method thereof.

### BACKGROUND

A multi-processor system becomes popular nowadays due to advance of the semiconductor process. Regarding a heterogeneous computing system, it has processors that are not identical. For example, the heterogeneous computing system may include at least one first processor and at least one second processor, where each first processor may have first processor architecture (e.g., first instruction set architecture), and each second processor may have second processor architecture (e.g., second instruction set architecture) that is different from the first processor architecture. Hence, if the same task is running on the first processor and the second processor, instructions executed by the first processor would be different from that executed by the second processor. In general, the first processor and the second processor implemented in the heterogeneous computing system have different computing power due to different processor architecture. For example, one of the first processor and the second processor may be used to serve as a main processor, and the other of the first processor and the second processor may be used to serve as an auxiliary processor. The data exchange is needed between the first processor and the second processor, which results in large communication overhead inevitably.

Thus, there is a need for an innovative data exchange scheme which is capable of reducing the data exchange overhead between different processing circuits (e.g., different processors) in a computing system.

### SUMMARY

In accordance with exemplary embodiments of the present invention, a computing system (e.g., a heterogeneous computing system or a homogeneous computing system) with reduced data exchange overhead and a related data exchange method thereof are proposed to solve the above-mentioned problem.

According to a first aspect of the present invention, an exemplary computing system is disclosed. The exemplary computing system includes a plurality of processing circuits and a storage device. The processing circuits have at least a first processing circuit and a second processing circuit. The storage device is shared between at least the first processing circuit and the second processing circuit. The first processing circuit is arranged to perform a whole cache flush operation to prepare exchange data in the storage device. The second processing circuit is arranged to get the exchange data from the storage device.

According to a second aspect of the present invention, an exemplary computing system is disclosed. The exemplary computing system includes a plurality of processing circuits and a storage device. The processing circuits have at least a first processing circuit and a second processing circuit. The storage device is shared between at least the first processing circuit and the second processing circuit. Concerning each task processed by the second processing circuit, the second processing circuit is arranged to refer to a cache flush decision to selectively perform a cache flush operation for storing at least a portion of a processing result of the task as part of exchange data in the storage device. The first processing circuit is arranged to get the exchange data from the storage device.

According to a third aspect of the present invention, an exemplary data exchange method is disclosed. The exemplary data exchange method includes: performing a whole cache flush operation upon a cache of a first processing circuit to prepare exchange data in a storage device shared between the first processing circuit and a second processing circuit; and getting the exchange data from the storage device for the second processing circuit.

According to a fourth aspect of the present invention, an exemplary data exchange method is disclosed. The exemplary data exchange method includes: concerning each task processed, referring to a cache flush decision to selectively perform a cache flush operation upon a cache of a second processing circuit for storing at least a portion of a processing result of the task as part of exchange data in a storage device shared between a first processing circuit and the second processing circuit; and getting the exchange data from the storage device for the first processing circuit.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram illustrating a first computing system according to an embodiment of the present invention.

FIG. 2 is a flowchart illustrating a data exchange method employed by a first processing circuit on a host side according to an embodiment of the present invention.

FIG. 3 is a flowchart illustrating a data exchange method employed by a second processing circuit on a device side according to an embodiment of the present invention.

FIG. 4 is a sequence diagram illustrating data exchange between a host side and a device side according to an embodiment of the present invention.

FIG. 5 is a diagram illustrating a second computing system according to an embodiment of the present invention.

FIG. 6 is a diagram illustrating a third computing system according to an embodiment of the present invention.

FIG. 7 is a diagram illustrating a fourth computing system according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

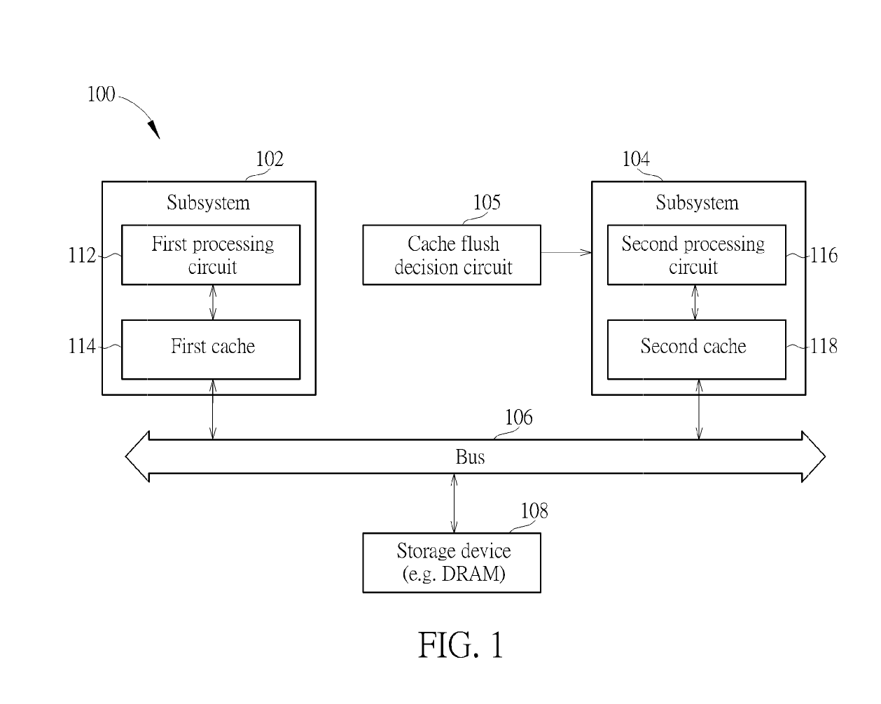

FIG. 1 is a diagram illustrating a first computing system according to an embodiment of the present invention. The computing system 100 includes a plurality of subsystems 102, 104, a cache flush decision circuit 105, a bus 106, and a storage device 108. The subsystem 102 includes a first processing circuit 112 and a first cache 114. The subsystem 104 includes a second processing circuit 116 and a second cache 118. In this embodiment, the subsystem 102 may be a host subsystem, and the subsystem 104 may be a device subsystem. In addition, the computing system 100 may be a heterogeneous computing system or a homogeneous computing system, depending upon actual design consideration.

In one exemplary design, the first processing circuit 112 may include one or more processors (or processor cores) sharing the same cache (i.e., first cache 114), and the second processing circuit 112 may include one or more processors (or processor cores) sharing the same cache (i.e., second cache 118). For one example, the first processing circuit 112 may be implemented using a central processing unit (CPU), and the second processing circuit 116 may be implemented using a graphics processing unit (GPU). For another example, the first processing circuit 112 on the host side may be implemented using a CPU, a GPU, a digital signal processor (DSP) or any other processor, and the second processing circuit 116 on the device side may be implemented using a CPU, a GPU, a DSP, a hardware circuit or any other processor. It should be noted that the first processing circuit 112 and the second processing circuit 116 may be implemented using processors of the same type or processors of different types. To put it simply, the present invention has no limitations on the actual implementation of the first processing circuit 112 and the second processing circuit 116. Any computing system or electronic device (e.g., mobile phone, tablet, wearable device, personal computer, notebook computer or any other device with multiple processing circuits) using the proposed data exchange scheme falls within the scope of the present invention.

The storage device 108 may be an external storage device, such as a dynamic random access memory (DRAM), and may be shared between the first processing circuit 112 and the second processing circuit 116. Hence, the storage device 108 may serve as a global buffer for storing read/write data of the first processing circuit 112 and the second processing circuit 116. Each of the first cache 114 and the second cache 118 may be an internal storage device, such as a statistic random access memory (SRAM). Hence, the first cache 114 may serve as a dedicated local buffer for caching read/write data of the first processing circuit 112, and the second cache 118 may serve as a dedicated local buffer for caching read/write data of the second processing circuit 118.

As mentioned above, the storage device 108 is an external storage device shared between the first processing circuit 112 and the second processing circuit 116. Hence, the first processing circuit 112 can access the storage device 108 via the bus 106, and the second processing circuit 116 can also access the storage device 108 via the bus 106. The first processing circuit 112 may prepare exchange data in the storage device 108, and the second processing circuit 118 may get the exchange data from the storage device 108 for further processing. In this embodiment, each of the first cache 114 and the second cache 118 may employ a write-back policy. In accordance with the write-back policy, write is done only to a cache initially, and the write to the backing storage is postponed until the cache contains data that is about to be modified/replaced by new data. Hence, before the second processing circuit 116 on the device side reads data updated by the first processing circuit 112 on the host side from the storage device (e.g., DRAM) 108, the first processing circuit 112 must flush (i.e., write back) the latest updated contents in “dirty” cache lines from the first cache 114 to the storage device (e.g., DRAM) 108. In this way, the second processing circuit 116 can get the latest updated contents from the storage device 108 after the first cache 114 is properly flushed.

Similarly, before the first processing circuit 112 on the host side reads requested data updated by the second processing circuit 116 on the device side from the storage device (e.g., DRAM) 108, the second processing circuit 112 must flush (i.e., write back) the latest updated contents in “dirty” cache lines from the second cache 118 to the storage device (e.g., DRAM) 108. In this way, the first processing circuit 112 can get the latest updated contents from the storage device 108 after the second cache 118 is properly flushed.

Based on the proposed data exchange scheme, the first processing circuit 112 can prepare the exchange data in the storage device 108 with reduced cache flush overhead. After the exchange data in the storage device 108 is processed by task(s) running on the second processing circuit 116, a processing result may be flushed from the second cache 118 into the storage device 108, and the first processing circuit 112 can get the processing result from the storage device 108. Further, based on the proposed data exchange scheme, the cache flush decision circuit 105 controls the cache flush operation performed by the second processing circuit 116 for reducing the cache flush overhead. Further details of the proposed data exchange scheme on the host side and the device side are described as below.

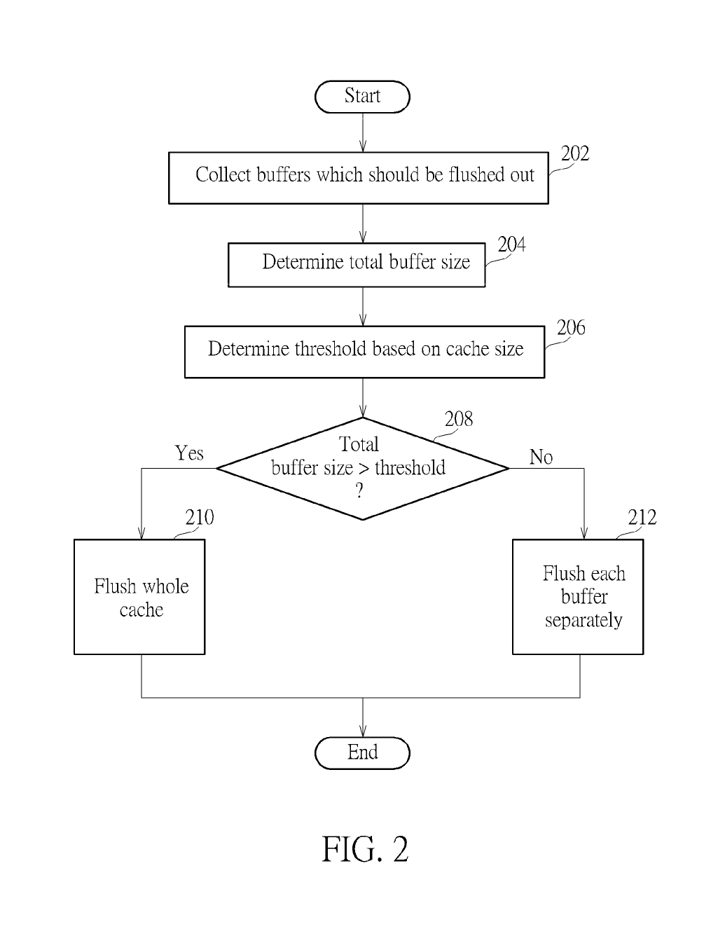

FIG. 2 is a flowchart illustrating a data exchange method employed by a first processing circuit on a host side according to an embodiment of the present invention. Provided that the result is substantially the same, the steps are not required to be executed in the exact order shown in FIG. 2. The exemplary data exchange method may be employed by the first processing circuit (e.g., CPU) 112 shown in FIG. 1. The first processing circuit 112 may allocate buffers in the storage device 108. For example, application(s) running on the first processing circuit 112 may allocate buffer(s) for storing application data (e.g., attribute data), where data in the allocated buffer(s) may be read by task(s) running on the second processing circuit 116 for further processing. In step 202, the first processing circuit 112 collects buffers which should be flushed out. For example, the buffers which should be flushed out may include buffers allocated in the storage device 108 that will be used by the second processing circuit (e.g., GPU) 116 on the device side. In step 204, the first processing circuit 112 determines the total size of buffers that should be flushed out. In step 206, the first processing circuit 112 determines a threshold based on the size of the first cache 114 (i.e., the cache size of the first processing circuit 112). By way of example, but not limitation, the threshold may be set by a value that is equal to the size of the first cache 114, or may be set by a value that is two times as large as the size of the first cache 114.

In step 208, the first processing circuit 112 checks if a predetermined criterion is met by comparing the total size of buffers that should be flushed out with the threshold determined based on the cache size. In this embodiment, the predetermined criterion (e.g., total buffer size>threshold) controls the enablement of a whole cache flush operation applied to the first cache 114. When the total size of buffers that should be flushed out is larger than the threshold, the first processing circuit 112 decides that the predetermined criterion is met. However, when the total size of buffers that should be flushed out is not larger than the threshold, the first processing circuit 112 decides that the predetermined criterion is not met. The cache flush operation performed by the first processing circuit 112 is controlled based on the checking result of the predetermined criterion. In some other embodiments, steps 202-208 may be performed by the second processing circuit 116 or any other device, which is not meant to be a limitation of the present invention.

In general, the first cache 114 is a small-sized buffer, such as a 512 KB cache. The first cache 114 may include “dirty” cached data that should be flushed to a buffer allocated in the storage device 108 for use by the second processing circuit 116, and may further include “dirty” cached data that needs not be used by the second processing circuit 116. Performing a cache flush operation for one buffer used by both of the first processing circuit 112 and the second processing circuit 116 may need to check each cache line in the first cache 114 to find out cached data that should be flushed to the buffer allocated in the storage device 108. When the first processing circuit 112 performs one cache flush operation for each buffer, there will be heavy cache flush overhead on the host side. When the predetermined criterion (e.g., total buffer size >threshold) is met, this means flushing the whole first cache 114 in one operation to write back all “dirty” cached data in the first cache 114, including “dirty” cached data that should be flushed to buffers allocated in the storage device 108 for use by the second processing circuit 116 and other “dirty” cached data that needs not be used by the second processing circuit 116, can effectively reduce the cache flush overload when compared to flushing each of the allocated buffers separately. Hence, when the predetermined criterion (e.g., total buffer size>threshold) is met, the first processing circuit 112 performs a whole cache flush operation upon the first cache 114 to prepare exchange data in the storage device 108 (Step 210). Hence, after the whole cache flush operation is done, the exchange data prepared in the specific buffers allocated in the storage device 108 would include latest updated contents flushed from the first cache 114.

However, when the predetermined criterion (e.g., total buffer size>threshold) is not met, this means it is possible that most of “dirty” cached data in the first cache 114 may not be used by the second processing circuit 116. Flushing the whole first cache 114 will result in too much data that is not intended to be shared between the first processing circuit and the second processing circuit 116 but flushed from the first cache 114 to the storage device 108. Hence, when the predetermined criterion (e.g., total buffer size>threshold) is not met, the first processing circuit 112 performs a cache flush operation for each buffer (which is allocated in the storage device 108 and shared by the first processing circuit 112 and the second processing circuit 116) separately (Step 212).

The second processing circuit 116 gets the exchange data prepared by the first processing circuit 112 from the storage device 108. In addition, the second processing circuit 116 performs one or more tasks to process the exchange data prepared by the first processing circuit 112, thereby generating a processing result of each task. If one cache flush operation is performed for the processing result of each task, there will be unnecessary cache flush operations on the device side since the first processing circuit 112 may not need or immediately need processing results of certain tasks. For example, when a processing result of a task includes intermediate data rather than final data needed by the first processing circuit 112, performing a cache flushing operation for flushing the intermediate data from the second cache 118 to the storage device 108 is unnecessary, which increases the cache flush overhead on the device side. The present invention therefore proposes selectively performing a cache flushing operation for a processing result of each task performed by the second processing circuit 116 to effectively reduce the cache flush overhead on the device side. In other words, a cache flushing operation for a processing result of one task may be performed, while a cache flushing operation for a processing result of a different task may be skipped.

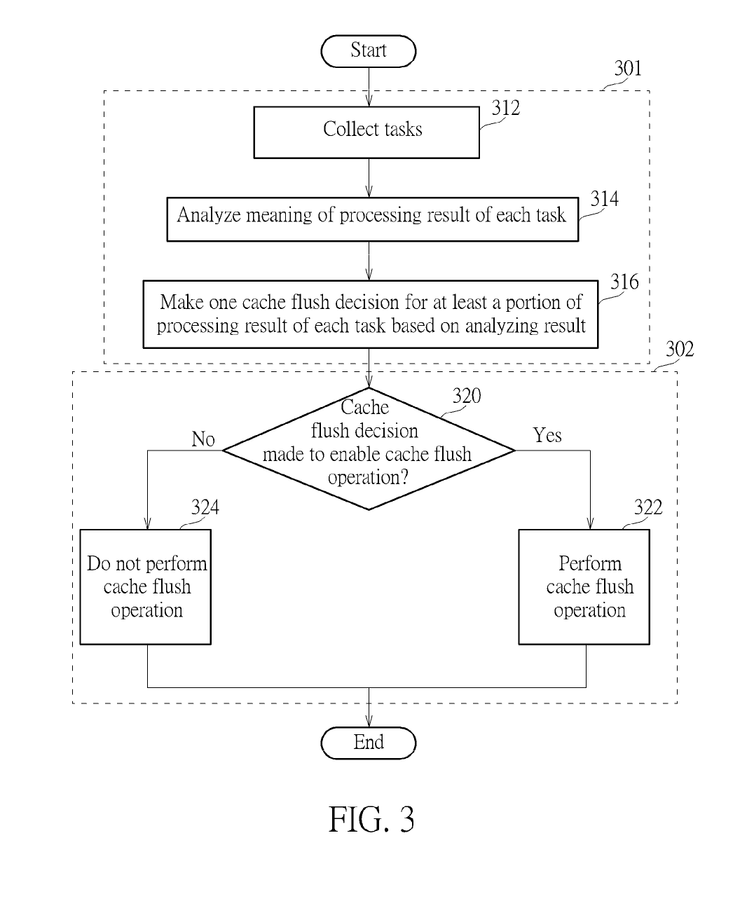

FIG. 3 is a flowchart illustrating a data exchange method employed by a second processing circuit on a device side according to an embodiment of the present invention. Provided that the result is substantially the same, the steps are not required to be executed in the exact order shown in FIG. 3. The exemplary data exchange method may include a cache flush decision making procedure 301 and a cache flush control procedure 302, where the cache flush decision making procedure 301 may be performed by the cache flush decision circuit 105 shown in FIG. 1, and the cache flush control procedure 302 may be performed by the second processing circuit (e.g., GPU) 116 shown in FIG. 1. The cache flush decision circuit 105 is used to generate a cache flush decision for each task (which is performed by the second processing circuit 116 based at least partly on data derived from the exchange data prepared by the first processing circuit 112 and stored in the storage device 108) automatically. In step 312, the cache flush decision circuit 105 collects tasks to be performed by the second processing circuit 116. Then, the following steps may be triggered. In step 314, the cache flush decision circuit 105 analyzes the meaning of a processing result of each task. In step 316, the cache flush decision circuit 105 makes one cache flush decision for at least a portion (i.e., part or all) of the processing result of each task based on an analyzing result obtained in step 314.

According to the design consideration, the processing result of each task may be partially or fully flushed from the second cache 118 to the storage device 108 in response to an enabled cache flush operation. In this embodiment, when the analyzing result indicates that at least a portion (i.e., part or all) of a processing result of a task is needed or immediately needed by the first processing circuit 112, an associated cache flush decision is made to enable a cache flush operation. However, when the analyzing result indicates that at least a portion (i.e., part or all) of a processing result of a task is not needed or immediately needed by the first processing circuit 112, an associated cache flush decision is made to disable/skip a cache flush operation.

Consider a case where the first processing circuit 112 is a CPU, and the second processing circuit 116 is a programmable processor such as a GPU. In addition to preparing the exchange data in the storage device 108, the first processing circuit 112 may further transmit a program code to the second processing circuit 104. For example, the first processing circuit 112 may execute a GPU driver to prepare the program code to be executed by the second processing circuit 104. Hence, the second processing circuit 104 may execute the program code configured by the first processing circuit 112 to perform tasks based at least partly on data derived from the exchange data prepared by the first processing circuit 112 and stored in the storage device 108. The first processing circuit 112 may further provide information of the program code to the cache flush decision circuit 105. Hence, the cache flush decision circuit 105 can easily accomplish steps 312 and 314 on the basis of the information of the program code. However, this is for illustrative purposes only, and is not meant to be a limitation of the present invention. Any means capable of determining whether a processing result of a task performed by the second processing circuit 116 on the device side is needed or immediately needed by the first processing circuit 112 on the host side may be employed by the cache flush decision circuit 105.

The cache flush decision circuit 105 generates one cache flush decision for each task to the second processing circuit 116. Concerning each task processed by the second processing circuit 116, the second processing circuit 116 therefore refers to an associated cache flush decision to selectively perform a cache flush operation for flushing at least a portion of a processing result of the task from the second cache 118 to act as part of exchange data prepared by the second processing circuit 116 and stored in the storage device 108, where the first processing circuit 112 can get the exchange data prepared by the second processing circuit 112 from the storage device 108. When a cache flush decision for at least a portion of a processing result of a task is made to enable a cache flush operation (step 320), the second processing circuit 116 is instructed by the cache flush decision to perform the cache flush operation to store at least the portion of the processing result of the task into the storage device 108 to serve as part of the exchange data prepared for the first processing circuit 112 (step 322). When a cache flush decision for at least a portion of a processing result of a task is made to disable/skip a cache flush operation (step 320), the second processing circuit 116 is instructed by the cache flush decision to avoid performing the cache flush operation upon at least the portion of the processing result of the task in the second cache 118 (step 324).

In one exemplary design, the cache flush decision may be configured to include at least a first decision and a second decision, where the first decision decides whether the cache flush operation is needed to be performed upon one cache level (e.g., level 1) of the second cache 118, and the second decision decides whether the cache flush operation is needed to be performed upon another cache level (e.g., level 2) of the second cache 118.

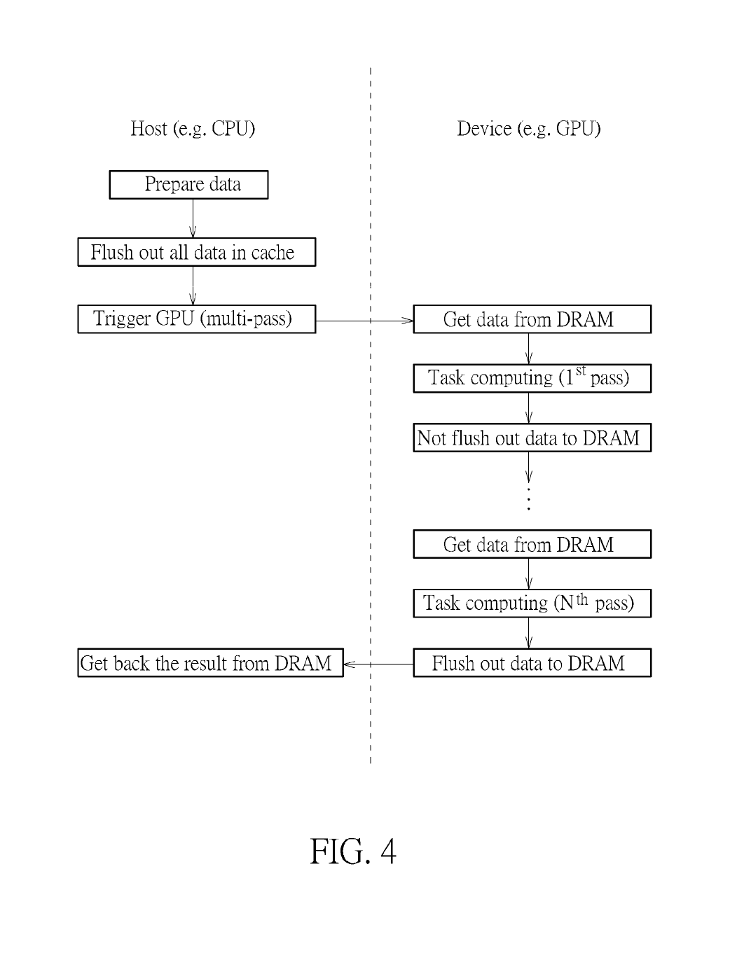

FIG. 4 is a sequence diagram illustrating data exchange between a host side and a device side according to an embodiment of the present invention. For example, a CPU may be located on the host side, and a GPU may be located on the device side. Compared to flushing out “dirty” cached data in a cache for each of a plurality of buffers separately, flushing out all “dirty” cached data in a cache in one operation (i.e., a whole cache flush operation) has acceptable overhead. Further, compared to flushing out data derived from each task to a shared storage device (e.g., a system DRAM), the proposed operation of referring to a cache flush decision to selectively flush out data derived from each task to the shared storage device (e.g., system DRAM) can remove unnecessary cache flush operations (e.g., a cache flush operation for a task of the 1^{st} pass shown in FIG. 4) for reducing the overhead. As a person skilled in the art can readily understand details of the data exchange process shown in FIG. 4, further description is omitted here for brevity.

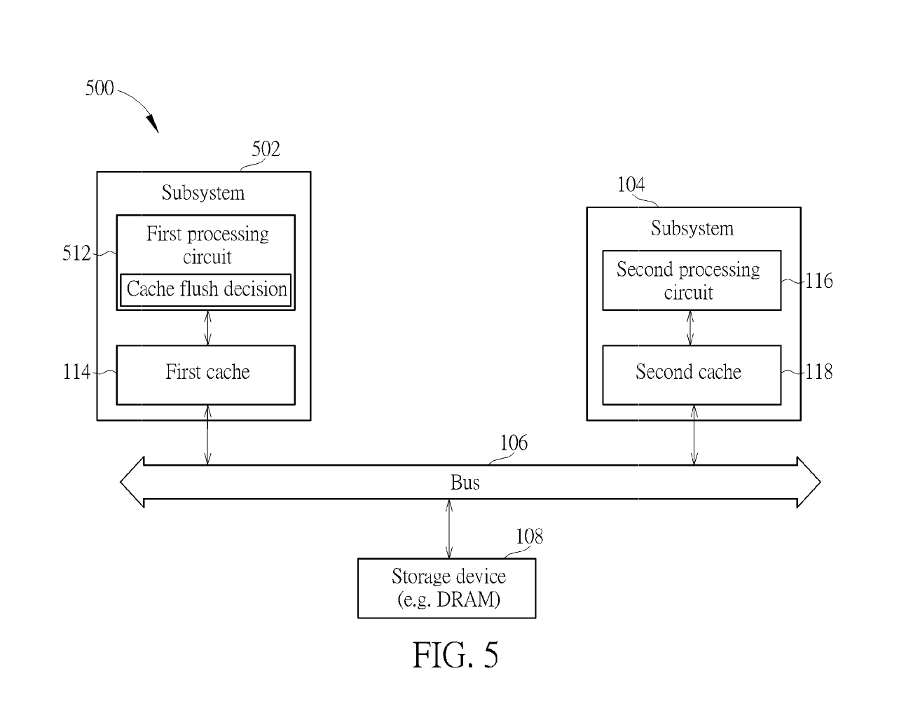

As shown in FIG. 1, the cache flush decision circuit 105 may be a hardware device different from any of the first processing circuit 112 and the second processing circuit 116. However, this is for illustrative purposes only, and is not meant to be a limitation of the present invention. In a first alternative design, a cache flush decision circuit (which is used to make a cache flush decision for each task automatically) may be part of a first processing circuit on a host side. FIG. 5 is a diagram illustrating a second computing system according to an embodiment of the present invention. The major difference between the computing systems 100 and 500 is that the cache flush decision circuit 105 is incorporated into the first processing circuit 512 of the subsystem 502 shown in FIG. 5. For example, the first processing circuit (e.g., CPU) 512 may execute a GPU driver to prepare the program code to be executed by the second processing circuit (e.g., GPU) 116 and further determine a cache flush decision for each task defined in the program code. Hence, the first processing circuit 512 further supports the cache flush decision function for making a cache flush decision for each task automatically, and outputs the cache flush decision of each task to the second processing circuit 116.

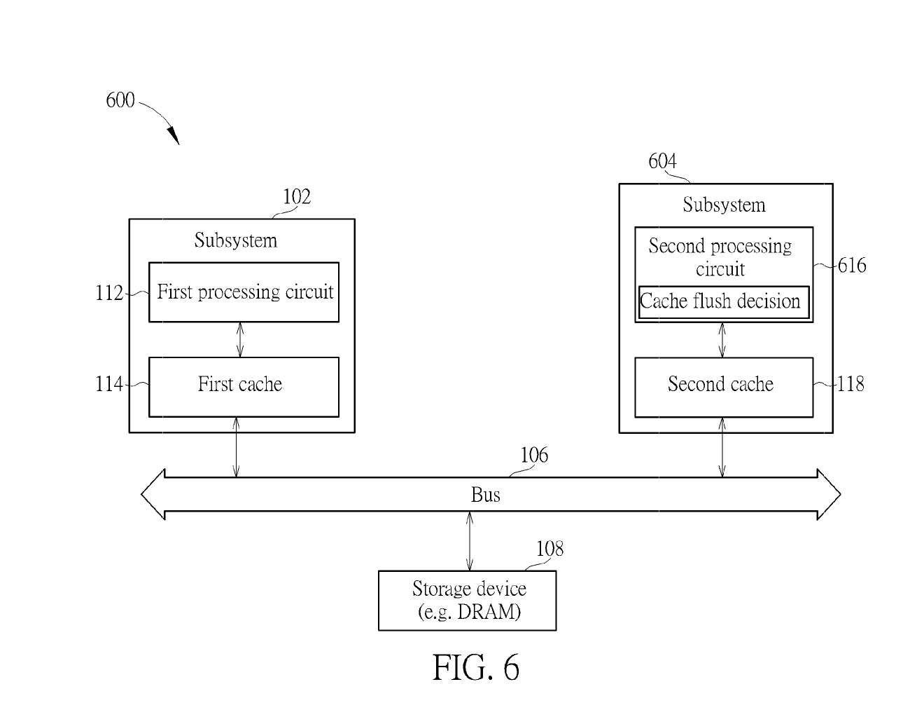

In a second alternative design, a cache flush decision circuit (which is used to make a cache flush decision for each task automatically) may be part of a second processing circuit on a device side. FIG. 6 is a diagram illustrating a third computing system according to an embodiment of the present invention. The major difference between the computing systems 100 and 600 is that the cache flush decision circuit 105 is incorporated into the second processing circuit 616 of the subsystem 604 shown in FIG. 6. Hence, the second processing circuit 616 further supports the cache flush decision function for making a cache flush decision for each task automatically.

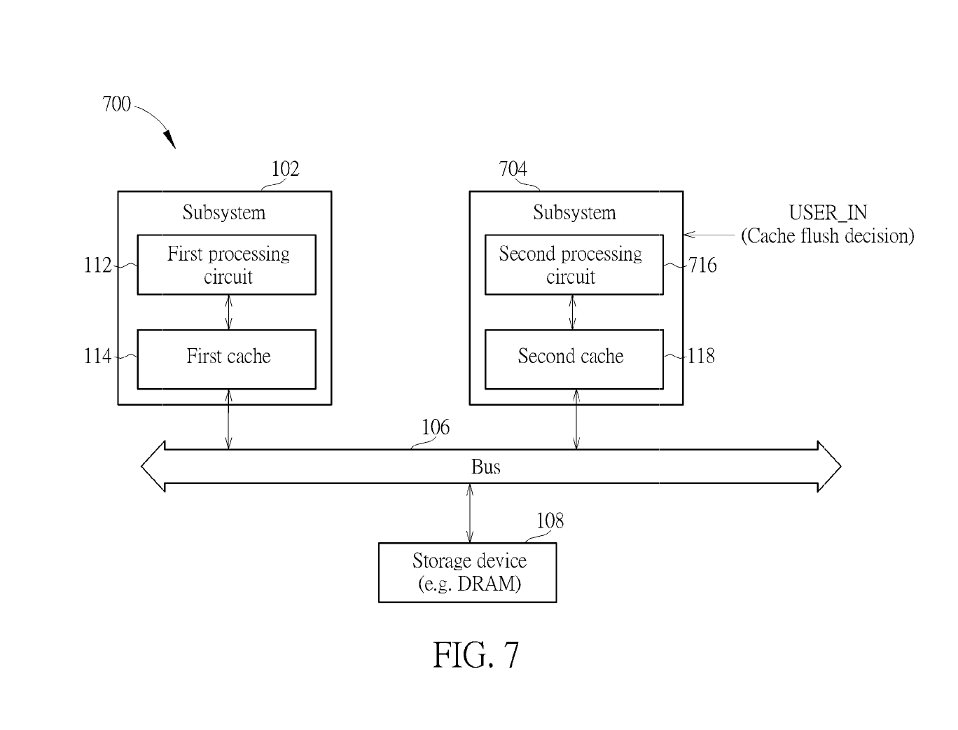

In a third alternative design, a cache flush decision for each task may be derived from a user input. In other words, the cache flush decision for each task may be configured manually. FIG. 7 is a diagram illustrating a fourth computing system according to an embodiment of the present invention. The major difference between the computing systems 100 and 700 is that the cache flush decision circuit 105 is omitted, and the second processing circuit 716 of the subsystem 704 shown in FIG. receives a user input USER_IN from a user interface (not shown), and then derives a cache flush decision from the received user input USER_IN.

Those skilled in the art will readily observe that numerous modifications and alterations of the device and method may be made while retaining the teachings of the invention. Accordingly, the above disclosure should be construed as limited only by the metes and bounds of the appended claims.

1. A computing system comprising:
a plurality of processing circuits, comprising at least a first processing circuit and a second processing circuit; and
a storage device, shared between at least the first processing circuit and the second processing circuit;
wherein the first processing circuit is arranged to perform a whole cache flush operation to prepare exchange data in the storage device, and the second processing circuit is arranged to get the exchange data from the storage device.

2. The computing system of claim 1, wherein the whole cache flush operation is performed by the first processing circuit when a criterion is met.

3. The computing system of claim 2, wherein the first processing circuit is further arranged to allocate at least one buffer in the storage device, where the exchange data is stored in the at least one buffer; and a total size of the at least one buffer is compared with a threshold to check if the criterion is met.

4. The computing system of claim 3, wherein the threshold is set based on a cache size of the first processing circuit.

5. The computing system of claim 3, wherein the criterion is met when the total size of the at least one buffer is larger than the threshold.

6. The computing system of claim 2, wherein the first processing circuit is further arranged to allocate at least one buffer in the storage device, where the exchange data is stored in the at least one buffer; and when the criterion is not met, the first processing circuit is further arranged to perform a cache flush operation for each of the at least one buffer, separately.

7. A computing system comprising:
a plurality of processing circuits, comprising at least a first processing circuit and a second processing circuit; and
a storage device, shared between at least the first processing circuit and the second processing circuit;
wherein concerning each task processed by the second processing circuit, the second processing circuit is arranged to refer to a cache flush decision to selectively perform a cache flush operation for storing at least a portion of a processing result of the task as part of exchange data in the storage device; and the first processing circuit is arranged to get the exchange data from the storage device.

8. The computing system of claim 7, further comprising:
a cache flush decision circuit, arranged to generate the cache flush decision automatically.

9. The computing system of claim 8, wherein the cache flush decision circuit is part of the first processing circuit.

10. The computing system of claim 8, wherein the cache flush decision circuit is part of the second processing circuit.

11. The computing system of claim 7, wherein the cache flush decision is derived from a user input.

12. The computing system of claim 7, wherein when at least the portion of the processing result of the task is needed by the first processing circuit, the cache flush decision is made to instruct the second processing circuit to perform the cache flush operation.

13. The computing system of claim 7, wherein the cache flush decision comprises at least a first decision and a second decision, the first decision decides whether the cache flush operation is needed to be performed upon one cache level, and the second decision decides whether the cache flush operation is needed to be performed upon another cache level.

14. A data exchange method comprising:
performing a whole cache flush operation upon a cache of a first processing circuit to prepare exchange data in a storage device shared between the first processing circuit and a second processing circuit; and
getting the exchange data from the storage device for the second processing circuit.

15. The data exchange method of claim 14, further comprising:
checking a criterion;
wherein the whole cache flush operation is performed when the criterion is met.

16. The data exchange method of claim 15, further comprising
allocating at least one buffer in the storage device, where the exchange data is stored in the at least one buffer;
wherein checking the criterion comprises:
checking if the criterion is met by comparing a total size of the at least one buffer with a threshold.

17. The data exchange method of claim 16, further comprising:
setting the threshold based on a size of the cache.

18. The data exchange method of claim 16, wherein the criterion is met when the total size of the at least one buffer is larger than the threshold.

19. The data exchange method of claim 15, further comprising:
allocating at least one buffer in the storage device, where the exchange data is stored in the at least one buffer;
wherein checking the criterion comprises:
when the criterion is not met, performing a cache flush operation for each of the at least one buffer, separately.

20. A data exchange method comprising:
concerning each task processed, referring to a cache flush decision to selectively perform a cache flush operation upon a cache of a second processing circuit for storing at least a portion of a processing result of the task as part of exchange data in a storage device shared between a first processing circuit and the second processing circuit; and
getting the exchange data from the storage device for the first processing circuit.

21. The data exchange method of claim 20, further comprising:
utilizing a cache flush decision circuit to generate the cache flush decision automatically.

22. The data exchange method of claim 21, wherein the cache flush decision circuit is part of the first processing circuit.

23. The data exchange method of claim 21, wherein the cache flush decision circuit is part of the second processing circuit.

24. The data exchange method of claim 20, further comprising:
receiving a user input; and
deriving the cache flush decision from the user input.

25. The data exchange method of claim 20, wherein when at least the portion of the processing result of the task is needed by the first processing circuit, the cache flush decision is made to enable the cache flush operation.

26. The data exchange method of claim 20, wherein the cache flush decision comprises at least a first decision and a second decision, the first decision decides whether the cache flush operation is needed to be performed upon one cache level of the cache, and the second decision decides whether the cache flush operation is needed to be performed upon another cache level of the cache.
